(19) United States
(12) Patent Application Publication
(10) Pub. No.: US 2009/0165866 A1
(43) Pub. Date: Jul. 2, 2009

(54) Valve With Built-In Sensor

(76) Inventor: Giovanni Fima, Oceanside, CA (US)

Correspondence Address: FISH & ASSOCIATES, PC;ROBERT D. FISH, 2603 Main Street, Suite 1000, Irvine, CA, 92614-6232, US

(21) Appl. No.: 12/343,230

(22) Filed: Dec. 23, 2008

Related U.S. Application Data
(60) Provisional application No. 61/009,473, filed on Dec. 28, 2007.

(51) Int. Cl. F16K 37/00

(52) U.S. Cl. 137/15.17; 137/551; 137/798

(57) ABSTRACT

A valve is disclosed that has a control ball. The control ball has a passageway within which a sensor is disposed. The sensor measures a characteristic of the fluid passing through the control ball. The control ball can be controlled either manually or with an electronic actuator. A method is disclosed of retrofitting an existing fluid distribution system by replacing a valve that lacks sensing capabilities with a new valve having a sensor. The sensor measures the flow, temperature, or pressure of the fluid, and provides a signal that can be remotely monitored and corresponds to the measured characteristic.

This application claims priority to U.S. provisional application with the Ser. No. 61/009,473, which was filed on Dec. 28, 2007. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is valves.

### BACKGROUND

There are two primary reasons for fluid leaks in a water system. The first is that plumbing is typically an open system. The second is that once a leak has begun, it often continues with devastating results. Fluid leaks, and particularly water leaks, can cause a significant amount of structural damage and health issues from resulting mold. In a major study of water leaks by FluidMaster™, the results indicated that 80% are caused by toilets, with 94% of all leaks occurring between the manual shut-off valve and the flexible line to the appliance. This stretch of plumbing is typically the weakest link in a water system and is prone to malfunction and rupture.

To reduce fluid leaks, recent developments in fluid distribution systems utilize sensors and control systems to proactively and automatically prevent leaks before they become problematic. For example, U.S. Pat. No. 7,319,921 to Underwood teaches a water treatment system that uses sensors, actuators, and a control system to monitor and control water flow. Additionally, U.S. Pat. No. 5,402,815 to Hoch teaches the use of temperature and moisture sensors to detect possible pipe freezing and leaks, and provides an automatic shut-off to a main water supply line. One problem with these systems is that they typically have many parts and require installation by a trained technician. In addition, such sensors generally can only be monitored locally and often require installation of extra components. Further, because fluid distribution systems are often complex and inaccessible (e.g., located underground, behind walls, etc.), multipart and complex systems become more difficult to install, replace and upgrade.

In addition to preventing leaks, it is advantageous to monitor fluid characteristics. Although it is common for gas and electricity to be measured especially by utility companies, the rise in the cost of water and the desire to promote water conservation, among other things, have led to an increasing desire and need to monitor the characteristics of water, such as flow, temperature and pressure. However, while sensors are simple to install during a new construction of a building, retrofitting an existing system is typically complex and cumbersome, especially as fluid systems are often inaccessible or otherwise difficult to reach, and often require extensive wiring. In addition, as the number of units and floors that need to be retrofitted increase, the cost often becomes prohibitive.

Thus, there is a need in the art for a valve having at least one built-in sensor. There is a further need for a valve and sensor that can be easily installed to replace an existing valve lacking sensing capabilities. In addition, a need exists for a system to provide for remote monitoring without the need for additional wiring.

### SUMMARY OF THE INVENTION

The inventive subject matter provides for apparatus and methods in which a valve having a control ball incorporates a sensor within a passageway of the ball. Such a valve can be used to regulate all kinds of fluids, including for example water or other liquids, and/or gases. In especially preferred embodiments, one or more valves are used in a water distribution system of a commercial or residential multi-unit building.

All commercially suitable types of ball valves are contemplated including for example, full port, standard port, reduced port, and “V” port ball valves. The control ball can be formed from any commercially practical material including for example, brass, stainless steel, plastic, ceramic, and any combination thereof. Preferably, the control ball is composed of a bimetal, and more preferably a bimetal of stainless steel and brass. In addition, the passageway of the control ball can regulate flow in at least one direction (e.g., a straight-through design). Other contemplated passageway designs include for example, a two-way and a three-way design. Furthermore, the passageway can be of sized and shaped as needed to conform to the system with which it will be integrated, though preferably the passageway has a cylindrical shape.

Any commercially available type of sensor that can be disposed within the control ball is contemplated including, for example, thermal, electromagnetic, mechanical, chemical, optical, and any combination of types of sensors thereof. Moreover, different types of sensors could be used depending upon the desired fluid characteristic to be measured. Specifically contemplated characteristics include the pressure, temperature, and flow rate of the fluid. In especially preferred embodiments, however, a magnetic turbine housing is used to measure the flow rate in combination with a Hall's effect reader. In further embodiments, at least two sensors, and preferably at least three sensors could be disposed within the valve to measure multiple fluid characteristics. Unless a contrary intent is apparent from the context, all ranges recited herein are inclusive of their endpoints, and open-ended ranges should be interpreted to include only commercially practical values.

The sensor could additionally include electronics that filter, amplify, or convert a signal from the sensor to assist in the signal's interpretation. For example, the electronics can convert at least one of a measured flow rate, temperature, and pressure into an electrical signal. All manner of commercially available electronics for conditioning signals are contemplated. Alternatively, a device external to the sensor can convert the signal. For example, the device could be adjacent to the sensor or otherwise coupled to the sensor.

In one aspect, the signal whether or not modified, could be sent to a controller. In especially preferred embodiments, the controller receives the sensor signal and can control a motor to turn the control ball and thus open or close the valve.

It is further contemplated that the sensor can be connected to a display that displays flow rate, a temperature, a pressure, and/or other characteristic of the fluid. In a highly preferred embodiment, information from the sensor could be displayed on a remote monitor (e.g., computer display, cell phone display, etc.).

In another aspect, a coupling for positioning upstream or downstream of a valve includes a flow sensor, a pressure sensor, and a temperature sensor. In especially preferred embodiment the coupling further comprises a check valve, and independently further comprises a turbine that operates to provide both flow and the pressure information.

In a further aspect, a fluid distribution system is retrofitted by replacing an existing valve lacking sensing capabilities with a new valve having a sensor. In this manner, retrofitting the existing valve with the new valve provides the additional ability for monitoring at least one characteristic of the fluid. The existing valve could be located inside or outside of a building, although it is preferably located inside of a multi-unit residential or commercial building. All manners of valves are contemplated to replace the existing valve, including for example, needle valves, ball valves, gate valves, poppet valves, plug valves, globe valves, butterfly valves, and diaphragm valves. However, it is especially contemplated that a ball valve having a built-in sensor could be used to replace the existing valve. Preferably, at least the first valve can be both manually and electronically actuated.

It is also contemplated that a second existing valve within the same fluid distribution system could be replaced with a second valve having a second sensor, similar to the first valve described above. Furthermore, a plurality of existing valves could be retrofitted, such as throughout a building to provide a plurality of valves that continuously monitor the properties of the fluid and can shut-off flow and communicate an alert to reduce the risk of water leaks. In addition, the new valve can optionally be placed to provide a drainage system to the existing distribution system to help prevent water leaks and/or pipe bursts. For example, a two-way and a three-way valve could be used in combination to provide a drain for fluid in the system by rotating the valves when a threshold temperature is reached.

The new valve is sized and configured to fit within the space vacated by the existing valve. However, it is also contemplated that artificial extensions could be used to lengthen the valve as needed to correctly fit within the existing system.

The sensor within the valve provides a signal that represents a specific property of the fluid including for example, a flow rate, temperature, and pressure. Any type of commercially available sensor is contemplated including those discussed above. In one aspect, a device remotely monitors the sensor signal. As used herein, “remotely” is defined as a distance of at least one foot, preferably ten feet, and more preferably 100 feet from the sensor. In addition, it is contemplated that the signal could be communicated with a remote computer and monitored via a computer interface. Thus, the computer could monitor a plurality of sensors and thus provide a central monitoring location. This can be advantageous in a building having multiple units and floors, such as a commercial high-rise. In this manner, a building manager can quickly be apprised of the status of the fluid system within the building and be immediately alerted to any problems.

In a further aspect, electronics could be installed within the sensor and the remote monitor to allow the signal to be communicated over a power line. This is advantageous as it allows the signal to be communicated to a remote device without the need for additional wiring. Such electronics could be configured to utilize an IP over power line connection. Alternatively, X10 modules could be coupled to the sensor and remote monitor for power line communication.

A controller can optionally be utilized and coupled to the sensor to provide a remote monitoring function. Preferably, the controller is configured to automatically monitor the signal. It is especially preferred that the controller could operate a motor coupled to the new valve and thereby control the valve remotely. The controller could also have electronics to allow communication over the power line, such as those described above. Thus, by plugging the controller into a standard power outlet, it could communicate over the power line, while providing power to any device coupled to it including for example valves, sensors, and actuators. In this manner, the controller could process a signal from the sensor, communicate it over the power line, and control the valve.

A display could be provided that displays information derived from the signal of the built-in sensor. Contemplated displays can range from a single light to an LCD screen or other display. For example, the valve having the sensor could have a monitor located adjacent to the valve that displays the current status of the system, as well as any or all of the monitored fluid characteristics.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a cross-sectional view of a valve having a built-in sensor.

FIG. 2 is a schematic of a valve having a built-in sensor with adjacent check valve and filter.

FIG. 3 is a cross-sectional view of the valve of FIG. 2.

FIG. 4 is a perspective view of the valve of FIG. 2.

FIG. 5 is a flowchart of a method of retrofitting an existing fluid distribution system.

FIG. 6 is a diagram of a pre-existing water system.

FIG. 7 is a diagram of the pre-existing water system of FIG. 6 with retrofitted valves.

FIGS. 8A and 8B are perspective views of a coupling for positioning upstream or downstream of a valve, which includes a flow sensor, a pressure sensor, and a temperature sensor.

FIG. 8B is another perspective view of the coupling of FIG. 8A, sensor.

FIG. 9 is substantially vertical cross-section of an alternative coupling, in which the sensor is clamped on the outside of the piping.

### DETAILED DESCRIPTION

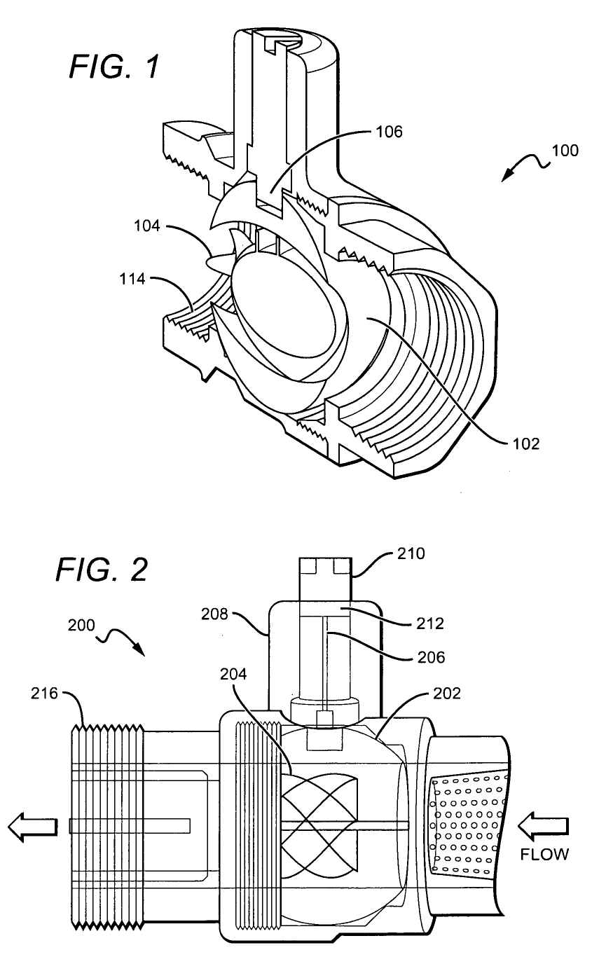

In FIG. 1, a valve 100 is shown comprising a control ball 102 with a sensor 106 disposed within the passageway 114 of the control ball 102.

Valve 100 is a ball valve that defines a fluid passageway 114. While a ball-valve is shown, it is contemplated that the valve can include any commercially available type of valve into which a built-in sensor can be disposed. Control ball can be composed of any suitable material including for example, metals such as stainless steel, chrome, and brass, plastics, ceramics, and any combination thereof. Although fluid passageway 114 has a one-way design, two-way, three-way, and other passageway designs are also contemplated. In addition, the passageways could be designed to direct flow in various directions including a direction normal to the fluid flow, such as through an “L”-shaped passageway.

Sensor 106 is a flow sensor comprising an electromagnetic sensor that operates in conjunction with turbine 104 having a magnet. Preferably, turbine 104 is configured to rotate around an axis generally parallel to the fluid flow. Such rotation could either be with or counter to the direction of flow. Thus, as the fluid causes the turbine to rotate around its axis, the sensor calculates the revolutions per minutes (RPMs) of the turbine, and thereby calculates the flow rate of the fluid. Sensor 106 can also calculate the pressure from the measured RPMs of the turbine. In addition, sensor 106 can further comprise a temperature sensor positioned within the control ball. While the axis of the turbine is shown as centered within the control ball, it is also contemplated that the axis could be located off-center. For example, the turbine could be positioned along a wall of the valve to lessen its impedance of the fluid flow. This could be advantageous as it allows the sensor to both monitor and control the fluid flow (e.g., closing the valve when a threshold level has been met).

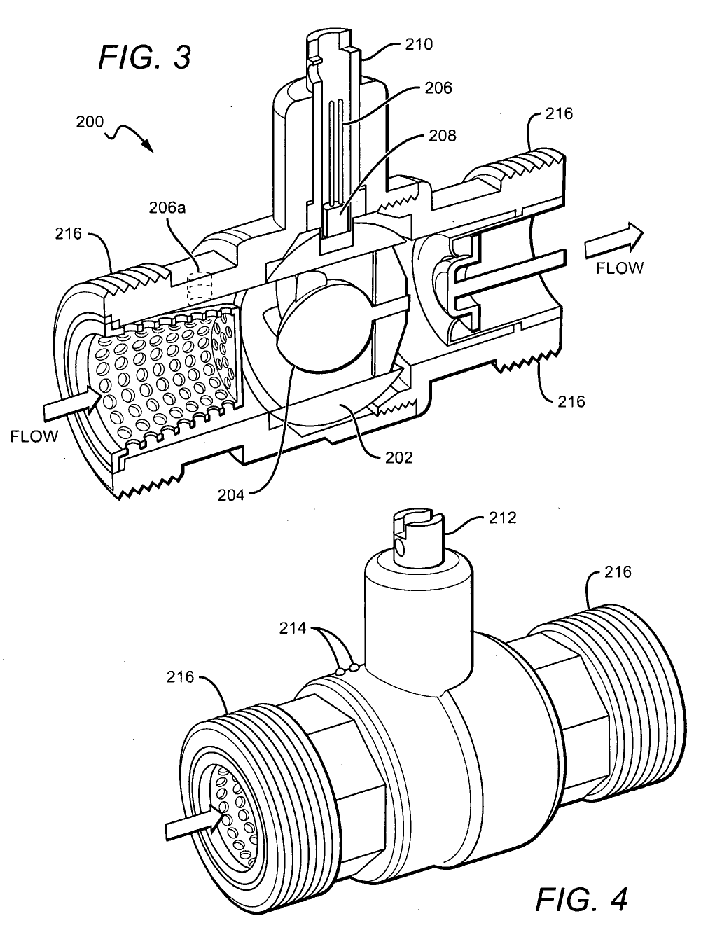

Turning to FIGS. 2-4, a valve 200 is shown comprising a control ball 202 having a sensor 206 disposed within the passageway 214 of the control ball 202.

Sensor 206 is a flow sensor having turbine 204 as described above. Sensor 206 preferably comprises electronics 208 configured to convert a measured fluid characteristic into an electronic signal. In addition, sensor 206 can comprise electronics configured to convert at least two measured fluid characteristics into separate electronic signals. Contemplated fluid characteristics include for example, flow rate, temperature, and pressure. Thus, for example, sensor 206 can detect at least two and preferably at least three fluid characteristics.

In addition to sensor 206, it is also contemplated that a second sensor 206a could be used to calculate other characteristics of the fluid including pressure and temperature. Thus, for example, preferably, at least two of flow, temperature and pressure could be measured. In a further embodiment (not shown), three sensors could be used to measure flow, pressure and temperature of a fluid. O-rings (not shown) could also be disposed around the sensor and valve as needed. While the second sensor 206a is shown upstream of the valve 200, it is also contemplated that the second sensor could be located downstream of the valve or within the valve itself.

Manual control 210 is used to allow for manual rotation of the control ball 202, such as with a screwdriver (not shown). Preferably, an actuator 212 (e.g., motor) shown in FIG. 2 is coupled with manual control 210 to allow automatic rotation of control ball 202. More preferably, actuator 212 comprises circuitry (not shown) configured to receive a pulse signal from a remote device and rotate the control ball upon receipt of the pulse signal.

Valve 200 also comprises at least one display 214, as shown in FIG. 4. Such display could be used to display the status of the valve and/or sensor, as well as the current measurement of at least one of flow rate, temperature and pressure. For example, the valve could illuminate a light to indicate that the valve is in a closed position. Preferably, a liquid crystal display (LCD) or other screen (not shown) could be used to allow the display of additional information.

In one aspect, valve 200 comprises fittings 206 at each end that are configured to allow the valve to be user-installed. For example, as shown in FIGS. 2-4, fittings 206 comprise helical grooves that can be threaded into corresponding receiving grooves of the existing system or threaded adapters (not shown) at the point of attachment. Thus, a user preferably can thread the grooves at each end of the valve into the respective receiving grooves of either the adapter or existing system and thereby create a sealed junction.

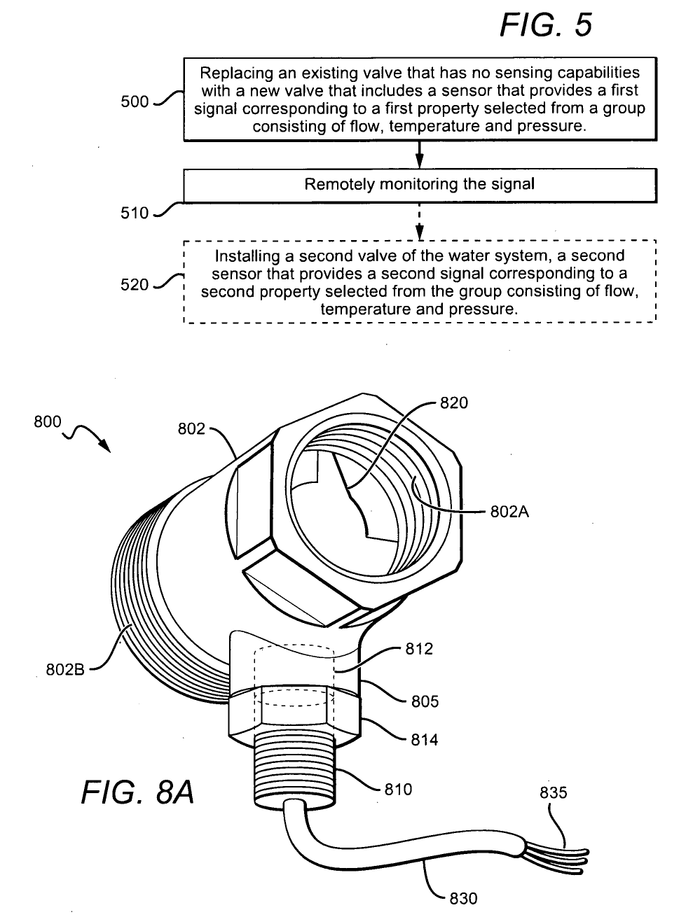

In a further aspect illustrated in FIG. 5, a method of retrofitting an existing fluid distribution system is described. Initially, an existing valve lacking sensing capabilities is replaced with a new valve (step 500). The new valve includes a sensor that provides a first signal corresponding to a first property selected from flow, temperature and pressure. The new valve can optionally include a monitor configured to display information derived from the measured characteristic of the fluid.

Next, the signal of the sensor is remotely monitored (step 510). Preferably, electronics are installed that carry the first signal of the sensor over the power line to facilitate the remote monitoring. Such remote monitoring could include a controller disposed remotely with respect to the sensor. In addition to receiving the sensor signal, the controller could optionally be provided with electronics configured to control the valve actuator and thus turn the control ball. In a further embodiment, the remote monitoring could be accomplished by a central monitor. Preferably, both the controller and central monitor can be used. In such an embodiment, the central monitor could communicate with the intermediary controller and thereby operate the valve motor.

Optionally, a second sensor can be installed at a second valve of the water system (step 520). The second sensor provides a second signal corresponding to a second property selected from flow, temperature, and pressure. In such an embodiment, it is especially preferred that a central monitor is used to remotely monitor the first and second sensors.

In addition, new valves having built-in sensors could also be installed without replacing existing valves. In another aspect, a plurality of valves having built-in sensors could be installed with a fluid distribution system to allow the fluid throughout a building's distribution system to be monitored.

Preferably, existing systems in multi-unit commercial or residential buildings can be retrofitted using the method described above. In addition, it is also contemplated that an irrigation system can be retrofitted using this system. In this manner, for example, the retrofitted building can have a valve with a fluid flow sensor at the main inlet for water at each unit. Thus, water flow could be shut-off when needed for maintenance or prevention of water leaks. In addition, using the built-in flow sensor, an accurate measure of the water use of the unit could be obtained, thereby providing a method of accurately tabulating the water usage of each unit. This is especially contemplated in combination with the remote monitoring as described above. Using the existing power lines, the sensor in each unit can communicate a signal to the monitor which can then tabulate and monitor water usage throughout the building.

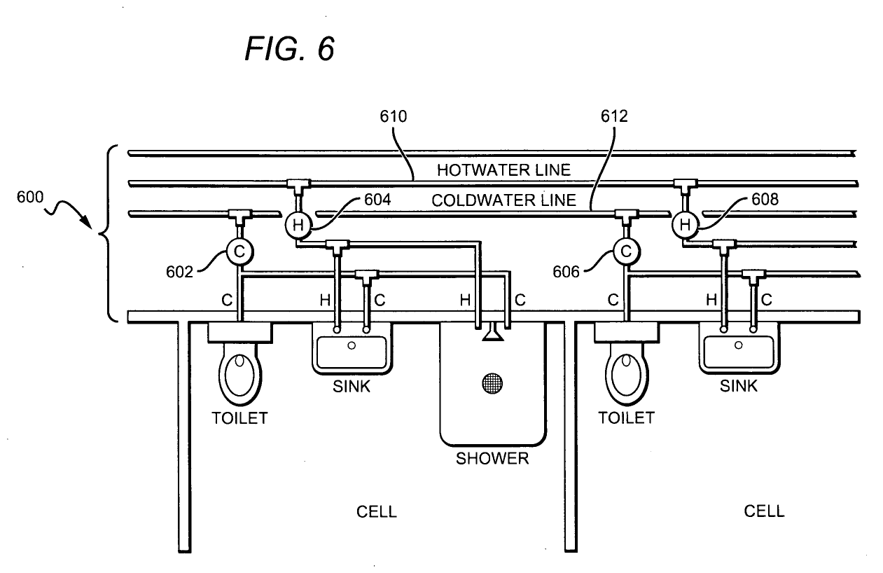

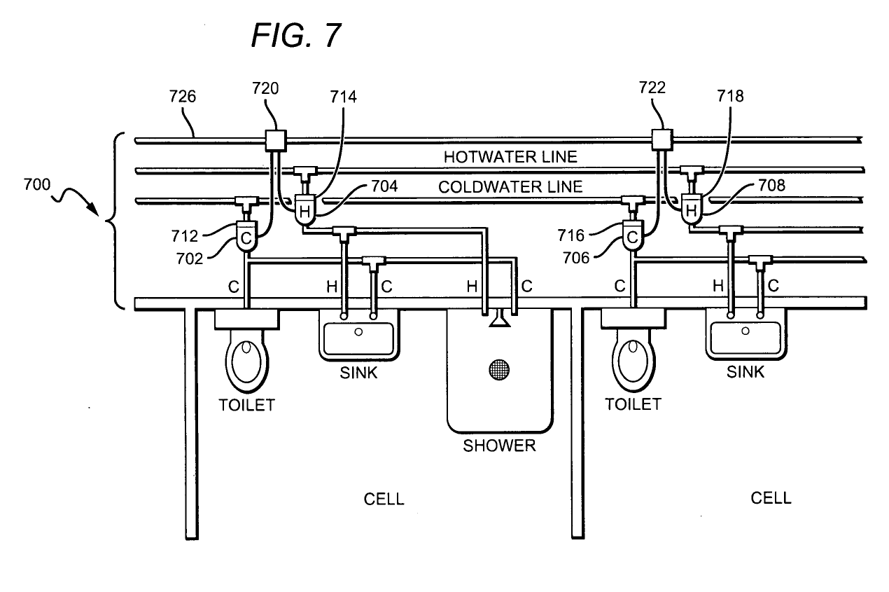

An exemplified embodiment of the method described above is illustrated in FIGS. 6-7. As shown in FIG. 6, system 600 comprises a hot 610 and cold water line 612. In addition, system 600 comprises existing valves 602-608 that lack sensing capabilities. A retrofitted system 700 is shown in FIG. 7 and comprises new valves 702-708, which replaced existing valves 602-608, respectively. Each of new valves 702-708 comprises sensors 712-718, respectively. Thus, in such an embodiment, the new system 700 can measure at least one fluid characteristic. Furthermore, the sensors 712-718 are connected to remote devices 720 and 722.

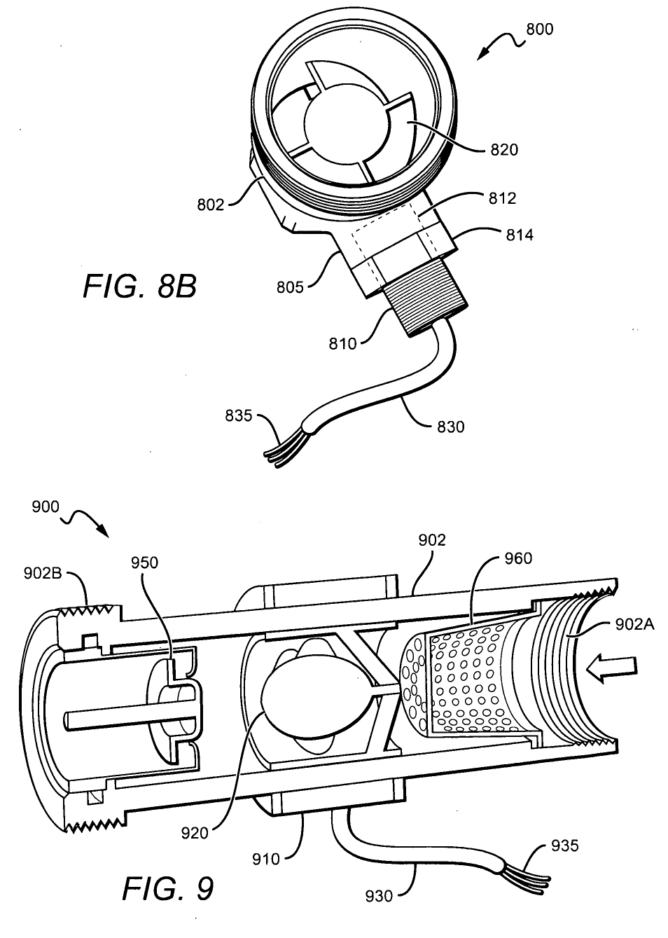

In FIGS. 8A and 8B a coupling 800, for positioning upstream or downstream of a valve (not shown), includes a sensor unit 810 that provides information as to flow, pressure, and temperature. In this instance the coupling 800 includes a turbine 820, the rotation of which is sensed by the sensor unit 810. Signals from the sensor unit 810 are carried by cable 830, and wires 835. Sensor unit 810 has threads 812 that screw into stem 805, and is held in place by nut 814. Also shown is a piping section 802 that terminates in female threads 802A on one end and male threads 802B on the other end.

FIG. 9 is a substantially vertical cross-section of an alternative coupling 900. In this instance, there is no stem equivalent to stem 810, and instead sensor 910 (which can detect flow and, pressure and temperature) is clamped on the outside of the piping 902. Signals from sensor 910 are carried by cable 930, and wires 935. FIG. 9 further depicts a turbine 910, which rotates in a manner that can be detected by the sensor 920, and check valve 950, and screen 960. Piping section 902 that terminates in female threads 902A on one end and male threads 902B on the other end. The turbines in FIGS. 8A, 8B and 9A are preferably magnetic, so that their rotation can be detected by the respective sensors 810 and 910.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A valve, comprising:
a control ball having a fluid passageway;
a sensor disposed in the passageway.

2. The valve of claim 1, wherein the sensor has electronics that converts a fluid flow rate to an electrical signal.

3. The valve of claim 2, wherein the sensor comprises a turbine.

4. The valve of claim 1, wherein the sensor detects flow using a magnet.

5. The valve of claim 1, wherein the sensor converts a temperature to an electrical signal.

6. The valve of claim 1, wherein the sensor converts a pressure to an electrical signal.

7. The valve of claim 1, further comprising a motor that turns the control ball.

8. The valve of claim 1, further comprising a display that displays at least one of a flow rate, a temperature, and a pressure.

9. A method of retrofitting an existing fluid distribution system, comprising:
replacing an existing valve that has no sensing capabilities with a new valve that includes a sensor that provides a first signal corresponding to a first property selected from the group consisting of flow, temperature and pressure; and
remotely monitoring the signal.

10. The method of claim 9, wherein the step of replacing the existing valve comprises installing the new valve in a portion of the fluid distribution system situated in a multi-family residential building.

11. The method of claim 9, wherein the step of replacing the existing valve comprises installing the new valve in a portion of the fluid distribution system situated in a multi-unit commercial building.

12. The method of claim 9, wherein the step of remotely monitoring comprises installing electronics that carries the first signal over a power line.

13. The method of claim 9, further comprising installing at a second valve of the water system, a second sensor that provides a second signal corresponding to a second property selected from the group consisting of flow, temperature and pressure.

14. The method of claim 13, wherein the step of remotely monitoring comprises utilizing a monitor that receives both first and second signals.

15. The method of claim 9, further comprising providing the new valve with a monitor that displays information derived from the first signal.

16. The method of claim 9, wherein the new valve is operated by an actuator, and remotely controlling the actuator.

17. A coupling for positioning upstream or downstream of a valve, the coupling having a flow sensor, a pressure sensor, and a temperature sensor.

18. The coupling of claim 1, further comprising a check valve.

19. The coupling of claim 1, further comprising a turbine that operates to provide both flow and the pressure information.
